(19) United States
(12) Patent Application Publication
(10) Pub. No.: US 2017/0104386 A1
(43) Pub. Date: Apr. 13, 2017

(54) Kinetic Energy System Utilizing Multi-size Multi-use High Speed Rotating Flywheel

(71) Applicant: Christopher M. MORRIS, Pottland, OR (US)

(72) Inventor: Christopher M. MORRIS, Pottland, OR (US)

(21) Appl. No.: 14/392,378

(22) PCT Filed: Jul. 28, 2014
(86) PCT No.: PCT/US14/00168

§ 371 Date: Mar. 3, 2016

(51) Int. Cl. H02K 7/02

(52) U.S. Cl. CPC H02K 7/025; H02K 53/00

(57) ABSTRACT

Processes used in the past were hazardous due to the material with which they were constructed, the design, and the location of the flywheel used on the device. In addition, the energy was inefficiently drawn from the flywheel which caused them to be replaced by fuel driven engines which emitted CO/2 and other greenhouse gases. My invention will create kinetic energy with zero greenhouse gases and all safety issues are remedied by high grade materials and new safety specifications. My invention is to turn a flywheel containing more kinetic energy than required by an electrical generator to produce power. The flywheel will be driven by an external energy source and, by overcoming the required kinetic energy of the electrical generator with the kinetic energy of the flywheel spinning at a high R.P.M., it will create kinetic energy.

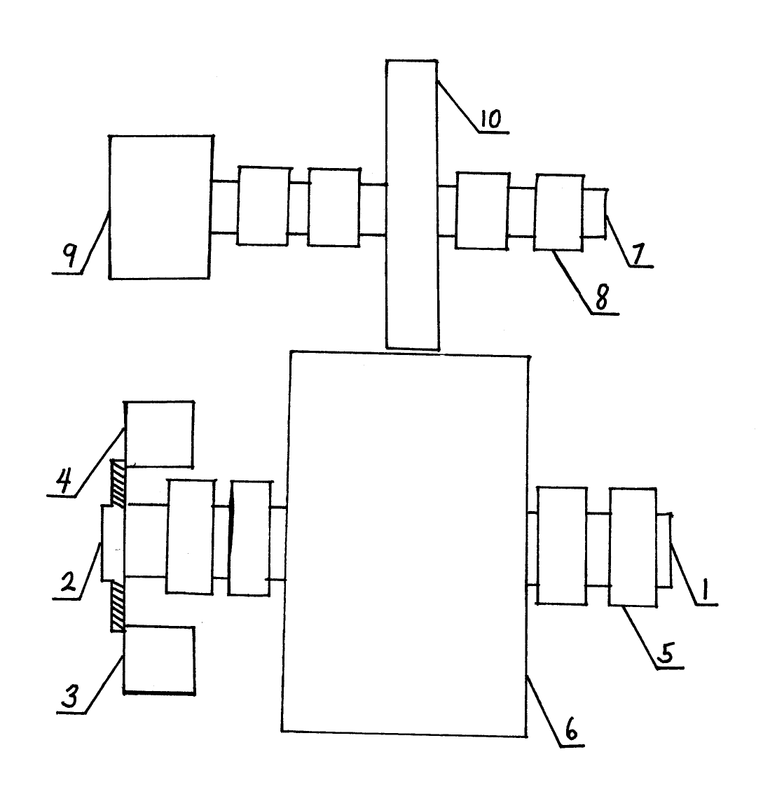

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not applicable

### BACKGROUND OF INVENTION

The field of endeavor to which this invention pertains is the generation of electricity and/or power, from watt size to gigawatt size.

Problems involved with past and presently used method of electrical power generation have been well documented in the media.

Hydroelectric power: The turbines or impellers are responsible for killing unknown trillions of small migrating fish and stop others from migrating at all and have taken up millions of miles of land that at one time was someone's home or grave.

Wind Turbine Power: Wind is not dependable and only produces in a small window of operational speed; the turbine must be taken offline during higher or lower wind speeds, and the output is only small megawatts per acre. They also kill many birds, bugs and insects that we need to pollenate our food chain. Very high, hard and dangerous to work on, imagine in winter at sea! Ocean units are greatly affected by previously listed concerns, in addition to hurricane seasons, tsunamis and other ocean anomalies.

Coal and Gas burning plants: No matter how well controlled and highly filtered, these put out the largest amounts of greenhouse gases and particulate matter into our atmosphere.

Biomass plants: These put out some greenhouse gases, but are a factor of our waste materials.

Solar Power: Is inefficient and only produces small amounts of electricity. The black panels generate a lot of heat back into the atmosphere that is just as bad as the greenhouse gases we are trying to stop any way. As far as the heat being generated by the large reflecting type of solar heating systems, these are even worse.

Nuclear power plants: Do I really need to list the number of things That are so wrong with this type of power system?

### BRIEF SUMMARY OF THE INVENTION

A general law of motion states that a large mass will stay in motion unless acted upon by an equal or greater opposite reaction. Utilizing a set of starter motors attached to the starting plate on the shaft of a flywheel, the kinetic energy system will rotate at a high rate of speed with an outer drive wheel maintaining the R.P.M.'s of the main spinning flywheel by the use of an electric motor on the drive wheel The input power will be added to the outer diameter of the flywheel, and the output energy will be drawn from the center of the shaft, providing a constant supply of kinetic energy which will turn an electric generator.

The advantages of the kinetic energy system will solve the previously existing hazards or problems listed in the Background section by overcoming all of those adverse impacts on the environment. There will be no turbines or impellers which kill or deter migrating fish, no waste of large tracts of land, no killing of birds, bees or other insects, no hazardous work conditions due to height or weather.

Instead of a low energy output per acre, it can produce an average of 625 megawatts per acre, be 100% green with zero carbon emissions or particulates, causing no heat to be generated back into the atmosphere, no transportation or storage problems which cause fires, explosions or spills, no time lost due to the need for long cooling or reheating processes.

The kinetic energy system will be self-energized and housed in a closed self- contained, environmentally controlled room or building on the ground or underground. This will prevent environmentally caused impacts on the system itself because, if located in areas prone to natural disasters such as hurricane, tornado, earthquake, volcanic ash, flood, drought or ice, the buildings can be adapted and strengthened to withstand catastrophic events.

### BRIEF DESCRIPTION OF THE SEVERAL VIEWS OF THE DRAWING

Page 1/1 shows a side view of the kinetic energy system.

### REFERENCE NUMERALS

1 Main flywheel support shaft
2 Main flywheel starter plate
3 Low speed starter motor
4 High speed starter motor
5 Main flywheel support shaft bearing
6 Main kinetic energy flywheel
7 Drive wheel support shaft
8 Drive wheel support shaft bearing
9 External input drive electric motor
10 External input drive wheel

### DETAILED DESCRIPTION OF THE INVENTION

The old method of applying power to the center of a flywheel and using the energy from the outside of a flywheel worked okay back in the 1800's, but there has been no further progress throughout the ensuing years.

For references to old flywheel uses, please see the following: www.youtube.com/watch?v=WEZjknUrUpw www.SRHF.ORG/Antique-Farm-Engines-at-FHF.pdf en.wikipedia.org/wiki/Hit-and-miss_engine-54k-

My method represents a different way of generating energy by applying external energy to the outside of the flywheel and drawing energy from the center of the flywheel, which makes it harder to drain the kinetic energy stored in the flywheel. My flywheel will spin at higher R.P.M.'s and produce higher amounts of useable kinetic energy at a constant rate, twenty-four hours per day, seven days per week, three hundred sixty-five days per year without catastrophic failure.

New technology has created so many advances that, for an example, instead of using cast iron as in the past, high quality rolled steel is available for use today.

In my system, the Main kinetic energy flywheel 6 will hang from the Main flywheel support shaft 1 and the Main flywheel support shaft bearing 5. The Main kinetic energy flywheel 6 will be put into motion, first by using the Low speed starter motor 3 located on the Main flywheel starter plate 2. Once the peak running speed has been reached, the High speed starter motor 4, located on the Main flywheel starter plate 2, will be used. When this peak running speed has been reached, the External input drive wheel 10, supported by the Drive wheel support shaft 7 and Drive wheel support shaft bearing 8, will be engaged, driven by the External input drive electric motor 9 to reach and maintain the required R.P.M.'s.

The size of the flywheel is determined by the amount of energy that is required by the systems to which it is being connected. In order to operate, a generator or engine requires a certain amount of pound-feet of torque. So as not to be slowed down by the kinetic energy being drawn from it, the flywheel spinning at its required R.P.M.s, will generate at least twice or more of the required pound-feet of torque in order to operate systems of any size to which it is attached. As an example: a 25 megawatt generator requires 35,290 H.P. to turn at 720 R.P.M.s (257,431.30 pound-feet of torque). My 15 foot diameter flywheel at 8 inches thick, weighing 57,734 pounds, spinning at 1,500 R.P.M.s will produce 123,668 H.P. (433,004 feet-pounds of torque). It will require a gear ratio of 2.5:1 reduction which will end up with a total of five times the generator's required feet-pounds of torque.

In attaching the various components of the kinetic energy system to one another, or the entire system to a framed unit, the attachments can be made with fasteners such as nuts, bolts, screws, set screws, sheer pins, end caps, and it can be welded, riveted, epoxied or by using any other attachment methods known in the art (not shown).

1. I have invented an electrically driven flywheel system which is a new method of producing the kinetic energy needed to supply the power required to turn generators or alternators and which is safe, dependable, 100% green and environmentally friendly.

2. A method according to claim 1 consisting of using electrically driven low speed and high speed starter motors applied to the starter plate on the support shaft to start the main kinetic energy flywheel, mounted on a horizontal shaft supported on bearings, which is then driven by a much lower voltage drive motor connected to the input drive wheel to reach and maintain the rpm's required to run an alternator or generator.

3. A method according to claim 1 which will provide the kinetic energy for any size generator or alternator and not be slowed down due to the energy being drawn from it; one example, with the flywheel size being determined by the needs of the generator, a fifteen foot diameter flywheel eight inches thick weighing 57,734 pounds, spinning at 1,500 rpm's produces 123,668 hp and 433,004 foot-pounds of torque, whereas a twenty-five megawatt generator requires only 35,290 hp and 257,431 foot-pounds of torque.

4. A method according to claim 1 which will be more dependable, located at ground level allowing for easier maintenance and repairs as opposed to being hundreds of feet in the air above land or sea, not involving depths of water, neither dealing with high temperatures nor extremely hazardous waste materials such as found in other power generation systems.

5. A method according to claim 1 using electricity to start and keep the kinetic flywheel turning continuously at the required speed, whether engaged or disengaged, makes this system 100% green, whereas other electric generation systems are not green energy, with hydro dams killing fish and stopping their migration, wind turbines killing many birds as well as insects that pollinate our food supplies, fuel burning generation plants emitting greenhouse gases, and nuclear power generation plants creating waste material that is difficult to contain and which remains hazardous indefinitely.
